(19) United States
(12) Patent Application Publication
(10) Pub. No.: US 2020/0233932 A1
(43) Pub. Date: Jul. 23, 2020

(54) PROVIDING ABILITY TO SIMULATE PRODUCTION SYSTEMS AT SCALE IN A FAST, SCALABLE WAY

(71) Applicant: Capital One Services, LLC, McLean, VA (US)

(72) Inventors: Vikramaditya REPAKA, McLean, VA (US); Andrew BALDWIN, McLean, VA (US); Renu RAI, McLean, VA (US); Mohammed ISHAQ, McLean, VA (US)

(73) Assignee: Capital One Services, LLC, McLean, VA (US)

(21) Appl. No.: 16/255,389

(22) Filed: Jan. 23, 2019

(51) Int. Cl. G06F 17/50

(52) U.S. Cl. CPC G06F 17/5009

(57) ABSTRACT

Various embodiments are generally directed to a simulation platform. The simulation platform may capture, audit, and/or store production data associated with a current production system. A virtual replica or copy of the of the current production system may be generated based on the production data. The simulation platform may receive one or more proposed modifications or changes to the current production system. Based on the proposal, a modified production system may be generated. Parallel simulations may be run on the virtual replica of the current production system and the modified production system, where analysis is performed on the simulations (and their respective outputs) and a result of the analysis is output to a user.

### BACKGROUND

Simulation is related to the imitation or modeling of a real-world system, process, or phenomenon. Simulations may be used in many different contexts, such as technology performance optimization, safety engineering, testing, training, education, manufacturing processes, supply chain processes, video games, natural systems, human systems, economics, and the like.

In business contexts, various aspects of a line-of-business (LOB) within a company, such as a financing LOB, may be simulated to observe the effects of proposed changes to the LOB prior to deploying those changes. Typically, to carry out the simulation, a business associate may instruct a technician to code and implement partial simulations. One issue, however, with having a technician code the simulation is that the desired changes or the goals of the simulation may get lost in translation between the technician and the associate. Thus, the simulation may not be coded as intended. Another issue with the simulation may be that it may capture only simple, basic level, and foreseeable effects or outcomes. To that end, the business associate may not be able to observe or analyze the higher-level, unexpected effects of the proposed changes, which may be critical to understanding the impact of those changes on the LOB.

Accordingly, there is a need for a powerful, high-performing, and scalable simulation platform that provides a holistic and accurate “sandbox” environment (instead of self-coded partial simulations), a way to observe and understand the multiple orders of effect associated with a very complex production system, and an interface for a user to directly enter the proposed changes in a simple and intuitive manner.

### SUMMARY

Various embodiments are generally directed to a simulation platform. The simulation platform may include at least two different types of simulation engines: a virtual replica or copy of a current production system and a modified production system. The replica or copy may be based on production data that has been audited, captured, and/or stored. The modified production system may be based on proposed modifications or changes input by a user. Simulations may be run on both engines based on historic production data that is input to the simulation platform. The results of the simulations may be analyzed and output to the user to analyze. If the user accepts the proposed modifications, then the simulation platform may automatically implement or deploy those changes in the actual production system.

### BRIEF DESCRIPTION OF THE DRAWINGS

FIG. 1 illustrates an example simulation platform in accordance with one or more embodiments.

FIG. 2 illustrates another example of a simulation platform in accordance with one or more embodiments.

FIG. 3 illustrates an example user interface in accordance with one or more embodiments.

FIG. 4 illustrates another example of a user interface in accordance with one or more embodiments.

FIG. 5 illustrates an example flow diagram in accordance with one or more embodiments.

FIG. 6 illustrates another example of a flow diagram in accordance with one or more embodiments.

FIG. 7 illustrates an example computing architecture of a computing device in accordance with one or more embodiments.

FIG. 8 illustrates an example communications architecture in accordance with one or more embodiments.

### DETAILED DESCRIPTION

Various embodiments are generally directed to a high-performing and scalable simulation platform. The simulation platform provides an accurate, holistic, and powerful sandbox environment for simulating at least two versions of a production system, both of which are self-contained in the simulation platform. One version may be a virtual replica or copy of a current-day production system, which may be the most up-to-date or most recent version of the production system (also may be referred to as current production system) prior to applying any modifications or changes. A second version may be a modified production system that incorporates one or more proposed changes to the current production system. In examples, the simulation platform may be entirely provisioned in a cloud environment.

It may be understood that the term “production system” may refer to a system (a computer system or otherwise) for supporting any aspect of an enterprise and/or line-of-business (e.g., financing, loan, mortgage, insurance, product, etc.). For example, a production system may be a vehicle financing system associated with a financial company, where the vehicle financing system receives, maintains, analyzes, and/or outputs various data or information related to the company's policies and other business-related variables or metrics associated with financing vehicles to consumers. The vehicle financing system, for instance, may calculate or keep track of profit (or other types of) targets based on differing credit score requirements for the consumers. In another example, the production system may be the company's mortgage loan system, servicing system, or the like. It may be further understood that a production system or any other production system described herein may be very complicated systems where the outcome, results, consequences, behavior, nature, etc. of the systems are not easily predictable or understandable.

In embodiments, the virtual replica or copy of the current production system may be built by performing data audits, or captures, on the current production system and storing the data so that the production system can be replicated in real-time. Stated differently, a data audit is a “save game” on all data or data lines corresponding to a production system so that the production system can be replicated or replayed.

In further embodiments, the modified production system may incorporate one or more proposed changes to the current production system. For example, a proposed change may be to modify (e.g., lower) a credit score requirement for a consumer-applicant when financing a specific make and model of vehicle. These types of changes may be proposed by any user, such as business associate, desiring to see what the proposed changes would look like and how they would affect the production system and the business prior to implementing those changes.

According to examples, both the virtual replica or copy of the current production system and the modified production system of the simulation platform may perform respective simulations. For instance, the simulations may be based on historic production data and/or modified historic production data, which will be further described below. A result of the simulation is the virtual replica outputting a first order effect, a second order effect, a third order effect, etc. The modified production system may also output a first order effect, a second order effect, a third order effect, etc. The different orders of effect are analyzed and compared with each other, the results of which may be presented to the user via an interface, as will be further described below. A first order effect may be the most immediate outcome (or a well understood cause and effect outcome) of the simulation, whereas the second and third order effects may be unexpected results and/or ancillary or ripple outcomes that are more difficult to anticipate or understand as a causal effect.

According to further examples, the user may accept the proposed changes, via the interface, based on observed outcomes of the simulation. Upon acceptance, the changes may be easily and seamlessly incorporated into the actual production system. Moreover, the interface may be configured so that the user, such as the business associate, may be able to enter the proposed changes to the production system directly on the interface itself.

In previous solutions, simulating aspects of a LOB or any system that supports the LOB has been difficult for various reasons, for example, the loss-in-translation problem between the user (e.g., business associate) and the technical implementor (e.g., programmer), the limited scope of being able to observe additional level of effects or outcomes of the simulation of a very complex system (which may lead to issues arising when taking the proposed changes to production), and the long delay from ideas of change to deployment. The various embodiments and examples of the simulation platform described herein overcome the above-described problems and are advantageous over the prior solutions for at least one or more of the following reasons. First, the simulation platform is a holistic and highly accurate sandbox environment since production data is audited and stored, for example, offline, so that the replication of the production system is unchangeable and self-contained. Second, the simulation platform allows the user, such as the business associate, to directly enter any proposed modifications via an interface without the help of a technician or programmer. In at least that regard, any loss in translation (which may also be known as “translation of intent”) may be minimized. Third, the simulation platform may output multiple levels of effect so that ripple or edge effects, including unexpected outcomes, can be accounted for and observed. Another advantage is that the simulation platform reduces the time from idea (e.g., the proposed changes) to deployment. Furthermore, an interface may be used so that the user can easily and intuitively see the comparisons between the simulations of the current production system and the system with the proposed changes. The interface also allows for easy interaction with the platform, as will be further described below.

Reference is now made to the drawings, where like reference numerals are used to refer to like elements throughout. In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form to facilitate a description thereof. The intention is to cover all modification, equivalents, and alternatives within the scope of the claims.

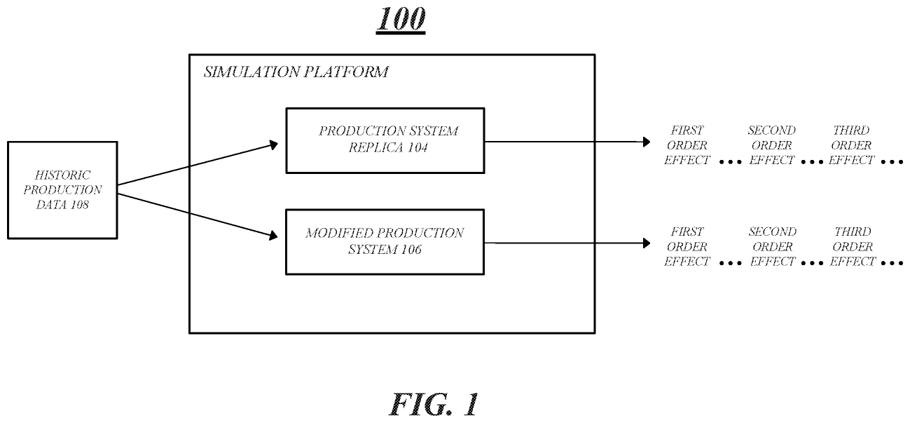

FIG. 1 illustrates an example simulation platform 100 according to one or more embodiments. As will be further discussed below, one or more computing devices, or processing circuitry thereof, may be operable to execute instructions that provide and support the simulation platform 100 and the various components therein. Moreover, it may be understood that the simulation platform 100 may be provisioned in a cloud environment.

As shown, the simulation platform 100 includes two different simulation engines, e.g., a production system replica 104 and a modified production system 106. The production system replica 104 is a virtual replica or copy of the current or current-day production system. For example, the current production system may be a system related to a line-of-business of an enterprise, such as a vehicle financing system. As will be further described below, the current production system is replicated based on production data (any data related to the production system and its functionalities, policies, etc. thereof) that has been captured, audited, saved, etc. from each production system at predefined intervals (e.g., every minute, every hour, every half-day, every day, every week, etc.) and/or the production data may be captured, audited, saved, etc. in a streaming manner, e.g., continuous manner, where, in examples, the data may captured be as it is streamed.

The modified production system 106 is a production system that incorporates one or more proposed modifications or changes to the current production system. For instance, the proposed modifications or changes may be a change in a parameter of a policy or rule related to an enterprise and/or a line-of-business, e.g., changing credit score requirements or any other suitable credit-related characteristics, changing income parameters or rules, changing interest rate parameters or rules, changing payment parameters or rules, changing borrower parameters or rules, etc., and further the proposed modifications or changes may also include adding and/or removing new parameters or rules. These changes, additions, deletions, etc. in the parameters or rules may be input into the simulation platform 100 by a user, such as a business associate. In at least that regard, the simulation platform can run two different simulations: one simulation on the production system replica 104 and the second simulation on the modified production system 106. The simulations may be run in parallel or may be performed in a staggered manner.

The simulations may be performed or run on historic production data 108 that is input into or received by the production system replica 104 and/or the modified production system 106, as shown, or made available for the simulation platform 100 to access, or in any other suitable manner. The historic production data 108 may be any real, concrete data related to the production system and its functionalities, for instance, spanning from a predetermined time prior to the simulation to the time of simulation. For example, the historic production data 108 may be at least financing-related data for all consumers that have or currently financing the specific vehicle, such as past payments, remaining balances, payment projections, consumer income information, interest rate data, profit margins, losses, other types of gains, etc. The historic production data 108 may be derived from consumer applications for loan financing, bills, digital records related to the financing, and/or the like. Accordingly, the production system replica 104 and the modified production system 106 may be able to accurately perform the simulations. In some examples, the historic production data 108 may be modified and input into the production system replica 104 and/or the modified production system 106.

As further shown, the simulation platform 100 may output at least two different sets of results. The first result may be output from the production system replica 104 and include at least a first order effect, a second order effect, and a third order effect. The second result may be output from the modified production system 106 and similarly, may include at least a first order effect, a second order effect, and a third order effect. The different orders of effect may represent the proximity (e.g., foreseeability) of the simulation outcomes. The first order effect may be the closest and most direct foreseeable outcome. But the higher order effects may include more complex and/or unexpected outcomes. For example, a first order effect of a simulation of a production system (either the production system replica 104 or the modified production system 106) requiring a predefined credit score for a vehicle may be that the company realizes a profit of a certain amount. A second order effect of the same example may be that the predefined credit score increases the interest rates for a set of consumers and could expose risks of default or non-payment by those consumers. A third order effect may involve a more complicated projection, such as how the predefined credit score can or would affect other LOBs within an enterprise. It may be understood that these effects are mere examples and are not limited thereto.

As will be further discussed below, the various orders of effect output by the production system replica 104 may be compared to the orders of effect output by the modified production system 106 so that that user (e.g., the business associate) may observe and analyze the consequences of the proposed changes prior to accepting and implementing those changes on the actual production system. It may be understood that the simulation platform 100 may include additional production system replicas and modified production system simulation engines for other types of production systems and not just the one illustrated in FIG. 1.

Moreover, it may be understood that the processing of the different simulation engines in the simulation platform 100 may be performed individually, staggered, in parallel, etc., and may be further understood that the output of the effects or outcomes of the simulations may be tailored to various needs of the user. Thus, if the user does not need to see simulation results from a specific replica, then the replica may be set so the results are not output. Nevertheless, the results may be used for analysis to show or highlight changes between the replica and the modified productions systems for the user.

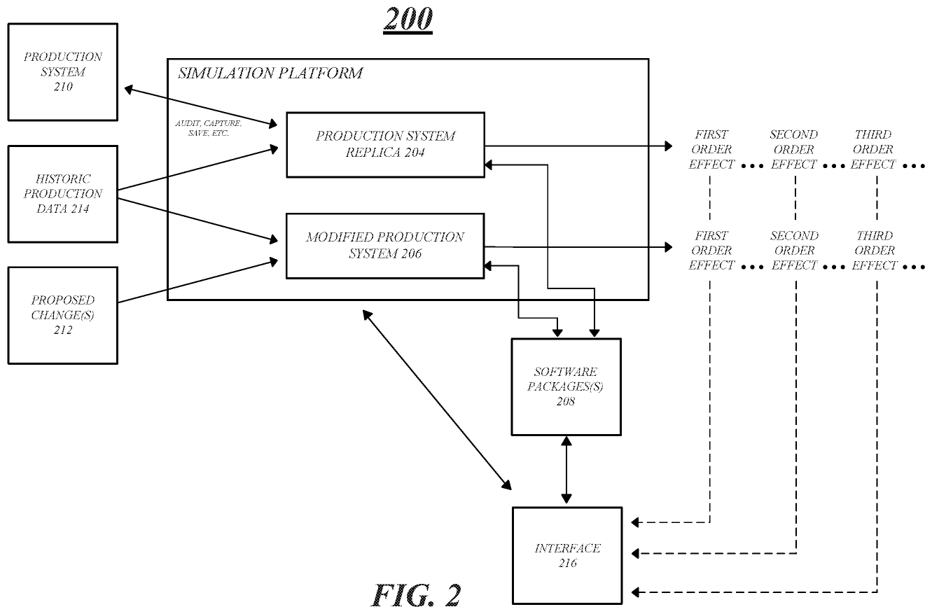

FIG. 2 illustrates another example of a simulation platform 200 according to one or more embodiments. Again, one or more computing devices, or processing circuitry thereof, may be operable to execute instructions that provide and support the simulation platform 200 and the various components therein. Similar to the simulation platform 100, the simulation platform 200 may also be provisioned in a cloud environment.

As illustrated, the simulation platform 200 includes a production system replica 204 and a modified production system 206. By way of example, the production system replica 204 and the modified production system 206 may be similar to the production system replica 104 and the modified production system 106, as described above.

The simulation platform 200 may be configured by provisioning a suit of microservices in the cloud for performing simulations and analyzing the results thereof. An example of a microservice or microservices may be one or more software packages 208 implemented on one or more cloud computing devices (or any other suitable computing device) to perform the simulations or may be configured to perform any other type of processing, computing, and/or the like corresponding to the simulation platform 200, as will be further described below. Thus, for example, the production system replica 204 may be generated by way of the one or more cloud-provisioned microservices. Moreover, the modified production system 206 may be generated in a similar manner—via the one or more microservices.

The production system replica 204 is a virtual replication or copy of an actual, current-day production system, e.g., production system 210. Production-related data, e.g., existing and/or currently implemented policies associated with the production system, from the production system 210 may be audited, captured, saved, etc. and may be used to generate and/or used by the production system replica 204 (as shown by the double-headed arrow therebetween). Thus, a “save game” is performed on each data line associated with each production system. In that regard, a virtual replica of the production system 210, e.g., the production system replica 204, is created in a sandbox environment, e.g., the simulation platform 200, to perform one or more simulations in real-time. Moreover, the production-related data may be saved or stored in at least one storage device offline. Because the data is directly audited, captured, and/or stored from the production system 210, the production system replica 204 is highly accurate, and thus, the replication of the production system 210 may be self-contained and/or unchangeable.

As described above, the production system 210 may be a vehicle financing system, but it may not be limited thereto and may include other types of LOB-related systems. The production system 210 may be any system (computer or otherwise) that supports any aspect of a LOB of an enterprise or company, such as financial products (e.g., loans, mortgages, etc.), products, services, etc. A user, such as a business associate of the company, may desire to see what a change or modification to the current-day production system would look like before implementing the change or modification. Accordingly, the modified production system 206, which is a separate simulation engine from the production system replica 204, may be provided by the simulation platform 200. The one or more proposed modifications or changes may be directly input by the user to the simulation platform 200, which may then be incorporated into the current production system (a virtual replica or copy like the production system replica 204) by the platform to provide the modified production system 206.

The one or more proposed modifications or changes, for example, may be changing a credit score requirement for a consumer when financing a specific vehicle, and/or in other examples any credit-related characteristic associated with a borrower, e.g., income, debt, timeliness of payments, risks, underwriting-assigned scores, etc. The business associate may, for instance, propose lowering a minimum credit score requirement when consumers finance a specific make and model of a vehicle. The business associate may directly input that proposed change into the simulation platform 200 via an interface, e.g., interface 216, which may allow the business associate to do so in an easy and intuitive manner, for example, inputting a table-based file, such as an excel file (or other types of files) specifying all the proposed changes. Thus, advantageously, the business associate is not required to communicate or work with a technician to simulate, implement, or code these changes, which could get lost in translation if required to do so. Other changes may include adjusting the interest rates for certain vehicles, lowering or increasing monthly payment amounts, and the like. It may be understood that the changes may not be limited to just these examples, but it may also include other suitable types of modifications related to any aspect of the production system supporting the LOB.

The production system replica 204 and the modified production system 206 may perform or run simulations on historic production data 214 that is input to or received by the simulation platform 200, as depicted by the arrows. As set forth above with respect to FIG. 1, the historic production data 214 may be any real, concrete data related to the LOB or LOB system, enterprise, etc., for example, payment histories of customers, customer information (e.g., income, credit scores, interest rates, financing histories, etc.) or any other suitable data, to help realistically perform the simulations. The historic production data 214 may originate from applications for financing or any other source of user qualification or the like.

The at least one software package 208 may be an operating-system-level virtualization software package that may contain computer program or code for performing operating-level virtualization (also known as “containerization”). The software packages may be otherwise referred to as “containers” or “docker containers.” The at least one software package 208 may be isolated from each other and bundle their own tools, libraries, and configuration files, but they can communicate with each other via well-defined channels. In examples, the at least one software package 208 may perform the analysis for determining the differences between the current production system (via the production system replica 204) and the modified production system 206 and/or the simulations, results, outcomes, etc. thereof. As shown by the double-headed arrows, the production system replica 204 and the modified production system 206 may be programmatically interfaced with the software package(s) 208 (and vice versa), and thus, the outputs, e.g., the first order effect, the second order effect, third order effect, of both simulation engines may be processed by the at least one software package 208.

For instance, the software package(s) may be configured to run simulations on the production system replica 204 and the modified production system 206. Each simulation may produce mock results, such as simulation results related to number of loans financed, profit per loan, losses per loan, projection of defaults, projection of on-time payments, projection of repeat customers, profitability projections, loss projections, compliance of internal or external policies, etc. Numerous metrics related to each simulation may be determined. For instance, the production system replica 204 may perform one or more projections based on the historic production data, e.g., one month out from a current time, six months out, a year out, or any other duration of time. Thus, various metrics associated with the current production system may be predicted by way of the simulation performed by the production system replica 204 in an accurate, sandbox environment without affecting or straining the performance of the real production system 210. Advantageously, the various metrics may be forecasted via the simulation, and further, various effects, e.g., first order effects, second order effects, third order effects, may be projected and observed, which would otherwise not be obtainable or observable in the real production system without simulation. The same may apply for the simulation of the modified production system 206, except the simulation would be run on a system having implemented the proposed changes 212. Moreover, in other examples, the metric results of the two simulations may be compared to each other and the differences therebetween may be determined, highlighted, and/or displayed to the user via interface 216. It may be understood that the software packages may be external to the simulation platform 200 or may be included therein. Moreover, it may be understood that the software package(s) 208 may be configured to execute different software packages to support various functionalities of the simulation platform 200.

The interface 216 may be a graphical user interface (GUI) or any other virtual or physical interface that allows the user to directly and easily interact with at least the simulation platform 200. The interface 216 may allow the user to view not only the first, second, and third order effects (and descriptions thereof), as indicated by the dashed lines, but may also be able to view the differences between the current production system 210 (via the production system replica 204) and the modified production system 206 with the proposed changes 212 incorporated therein. As set forth above, the differences between the two systems may be analyzed and compared by the software package(s) 208. It may be understood that the interface 216 may be used to interact with the simulation platform 200 (as indicated by the double-headed arrow) in other suitable ways.

It may be understood that the simulation platform 200 may be run and/or supported by its own dedicated server computers or any other dedicated computer(s). Thus, advantageously, the simulation platform may be able to run separately and independently from the computing components supporting the actual production system(s) while being able to capture, audit, and/or save any data originating from those components. Moreover, as set forth above, it may be understood that the simulation platform 200 may include many other simulation engines (both the production system replicas and the modified production system) for other various types of production systems.

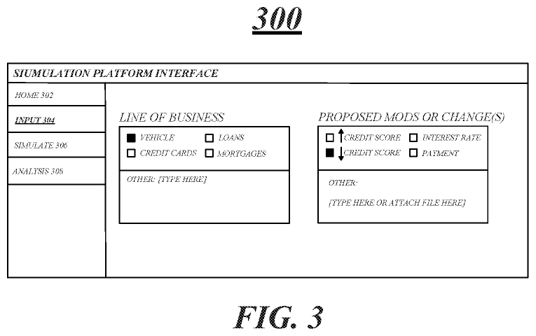

FIG. 3 illustrates a simulation platform user interface 300 in accordance with one or more embodiments. A user, such as the above-described business associate, for instance, may interact with the simulation platform via the interface 300, which may be a graphical user interface (GUI) that may be displayed by one or more computing devices, or the like.

As shown, the example interface 300 includes various icons on the left-hand side or column: a home icon 302, an input icon 304, a simulate icon 306, and an analysis icon 308. The input icon 304, when selected, allows the user to interact with the simulation platform. For example, the user may be able to select a LOB production system (e.g., vehicle financing, loans, credit cards, mortgages, etc.) of a specific enterprise that the user desires to change or modify. In some embodiments, the user may be able to type in a different LOB in the “other” box, if that LOB is available for simulation.

Moreover, as further shown, the user may be able to input the one or more proposed modifications or changes to the selected LOB via the interface 300. For example, the modifications or changes may be presented to the user for easy selection. There may be at least a credit-score-increase icon, a credit-score-decrease icon, an interest rate icon, and a payment icon. The user may also be able to type in specific information related to either the selected change or any other changes that are not displayed into the “other” box. Additionally, in examples, the user may be able to “drop” or attach files, such as an excel file, that includes the numerous and various changes to the LOB production system. In this regard, the user may be able to directly input the proposed changes into the simulation without the help of a technician or programmer, which is advantageous over prior solutions. It may be understood that other credit-related characteristics, such as a credit-related value associated with a borrower, income, debt, timeliness of payments, risks, underwriting-assigned scores, and the like, may also be presented for modification on the interface 300, and not limited to modifying a credit score.

The simulate icon 306 may be selected to specify or customize various parameters of the simulation and the associated simulation engines. Thus, the interface allows greater flexibility. It may be understood that many more icons that are not shown may be included in the simulation platform user interface 300. For example, an “accept change” icon may be included where the user may be able to confirm all relevant changes and allow the simulation platform to deploy those changes into the actual production system.

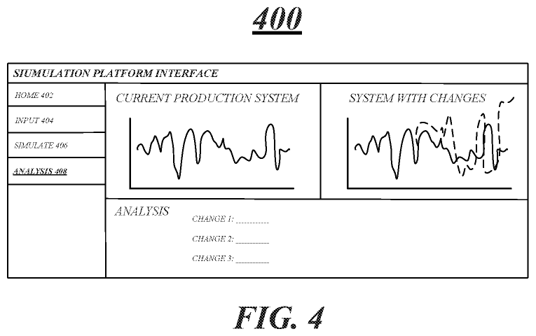

FIG. 4 illustrates an example simulation platform user interface 400 in accordance with one or more embodiments. As shown, the interface 400 is similar to interface 300 in that multiple icons are displayed on the left-hand side or column: a home icon 402, an input icon 404, a simulate icon 406, and an analysis icon 408. This time, the user may select the analysis icon 408, whereby the interface 400 displays at least three different boxes to the user.

The first box may display various metrics associated with the current production system. For example, after simulating the current production system, it may display different projections—graphically, textually, etc., to the user for analysis and observance. The box to the right of that box may display the modified production system indicating the changes to the current production system (e.g., the changes indicated in a dashed line in the illustrated graph). The box below may textually display and itemize the various changes that are output after performing the simulation on the modified production system, such as “change 1,” “change 2,” change 3,” etc. Accordingly, the user may be able to observe all the consequences of making the proposed changes to the current production system and make an educated and informed decision prior to implementing those changes.

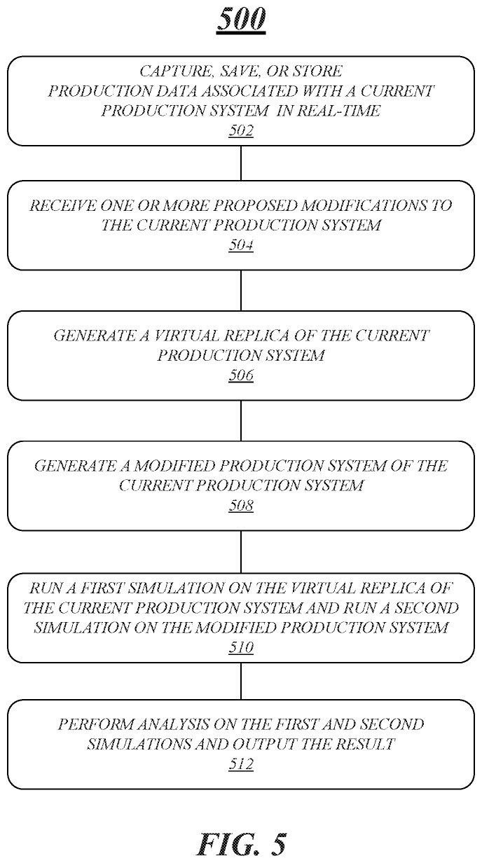

FIG. 5 illustrates a flow diagram 500 in accordance with one or more embodiments. It may be understood that the features associated with the illustrated blocks may be performed or executed by one or more computing devices and/or processing circuitry contained therein, and not in any particular order. For example, the computing devices may support the simulation platform.

At block 502, production data associated with a current production system may be captured, saved, or stored in real-time. A simulation platform, for example, performs a “save game” on each data line associated with a production system, and thus, all data associated with each production system is used to build the virtual replica or copy of the current production system. In examples, the production data may be stored offline.

At block 504, the simulation platform receives one or more proposed modifications or changes to the current production system. The modifications or changes may be input by a user, such as a business associate, who may want to observe or analyze the consequences of those modifications or changes prior to deploying or implementing them in the real production system. An advantage of the simulation platform is that it allows the user to directly enter the proposed modifications without the help of a technician, thereby eliminating any translation-of-intent issues or the like.

At block 506, a virtual replica or copy of the current production system is generated. As described above, one or more cloud-provisioned microservices, e.g., cloud-provisioned software packages, may perform the generation of the virtual replica or copy, which may be based on the production data that was captured, saved, or stored at block 502. The production data may be indicative or represent the current policies, rules, etc. associated with the production system. At block 508, the modified production system is generated, which may be at least based on the modifications or changes received at block 504. As set forth above, the simulation platform employs two separate simulation engines: the virtual replica or copy of the current production system and the modified production system. This allows for parallel simulation as well as the comparison and/or analysis of the results of the simulation (e.g., first order effects, second order effect, third order effects, etc.).

At block 510, simulations are run on historic production data via both the virtual replica (first simulation) and the modified production system (second simulation), where the different simulations may be staggered or may be performed simultaneously. As set forth above, the historic production data, which is any real, concrete data that is related to the production system itself. In examples, the simulations produce results, outcomes, consequences, etc.—both expected and unexpected, where analysis is performed on first and second simulations and the results of the analysis output at block 512. An advantage of the simulation platform is that higher level outcomes or edge consequences—outcomes that may not be easily foreseeable—may be simulated and output to the user for consideration. The analysis at block 512 may involve comparing the two simulations and highlighting the changes between the current production system and the modified production system and outputting the changes for a user via an interface.

It may be understood that the blocks illustrated in FIG. 5 are not limited to any specific order. One or more of the blocks may be performed or executed simultaneously or near simultaneously.

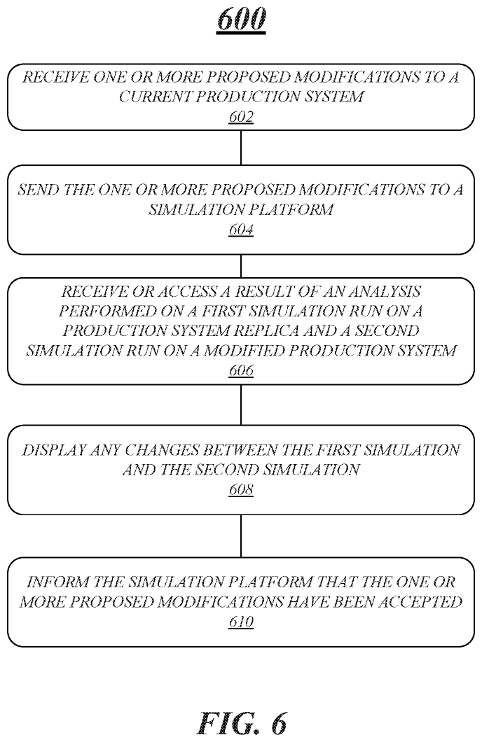

FIG. 6 illustrates a flow diagram 600 in accordance with one or more embodiments. It may be understood that the features associated with the illustrated blocks may be performed or executed by one or more computing devices and/or processing circuitry contained therein, and not in any particular order. For example, the computing devices may be a user computing device for communicating with a simulation platform.

At block 602, one or more proposed modifications or changes to a current production system is received by the computing device(s). These modifications or changes may be entered or input by a user, such as a business associate. Moreover, the proposed modifications may be easily formattable file, such as an excel file, for the user to input to the simulation platform.

At block 604, the user computing device may send to the simulation platform the one or more proposed modifications or changes. The simulation platform, as set forth above, may then run simulations on a production system replica and a modified production system with the one or more proposed modifications incorporated therein. Analysis on the simulations may also be performed by the simulation platform. As described above, running a simulation on the historic production data by the production system replica has numerous advantages. By way of example, the production system replica may perform one or more projections, e.g., projection of various metrics related to the simulation, projected out for a duration of time relative to a current time, e.g., one month out, six months out, a year out, etc. Thus, projections related to the current production system may be forecasted via the simulation in an accurate, sandbox environment without affecting or straining the performance of the real production system. In other words, the simulation is entirely separate from the actual production system infrastructure. The results of the simulation performed by the production system replica may thus be useful to the user to not only analyze and observe projections but also to observe the multiple order effects that may otherwise not be currently observable in the real production system.

At block 606, a result (or results) of the analysis performed by the simulation platform on a first simulation performed on the production system replica and a second simulation run on the modified production system may be received or accessed by the user computing device.

At block 608, the changes between the first simulation and the second simulation (e.g., the differences between the current production system and the modified production system) may be displayed to the user via an interface. As set forth above, the user may be able to analyze the results, outcomes, consequences, etc. of the simulations, and in response, either accept or decline the proposed modifications prior to deploying them in the actual production system.

At block 610, when the user accepts the proposed modifications, the user computing system informs the simulation platform that the user has accepted the one or more proposed modifications to the current production system. In examples, the simulation platform may then automatically implement or deploy those modifications in the actual production system.

It may be understood that the blocks illustrated in FIG. 6 are not limited to any specific order. One or more of the blocks may be performed or executed simultaneously or near simultaneously.

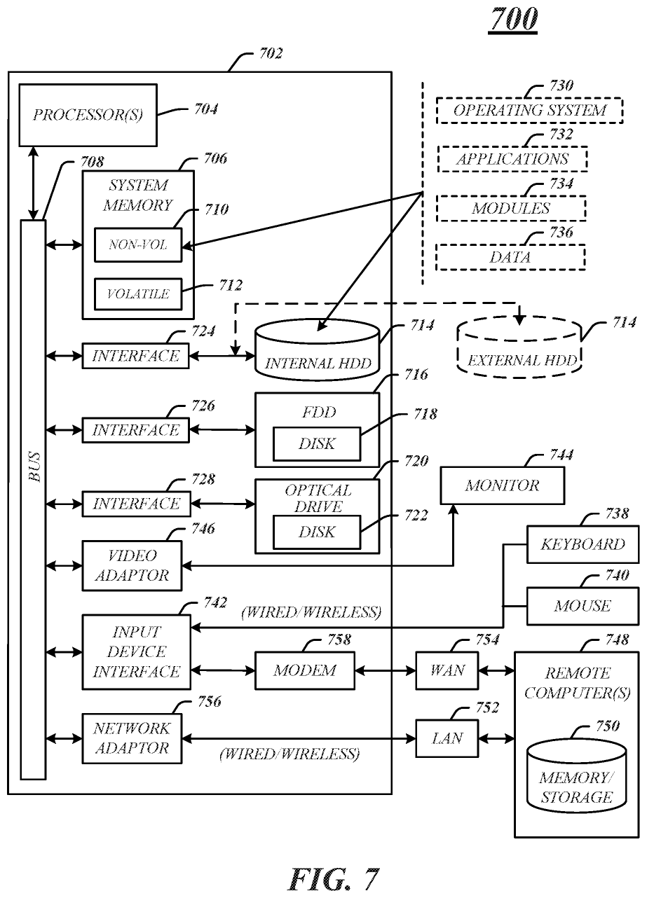

FIG. 7 illustrates an embodiment of an exemplary computing architecture 700, e.g., of a computing device, such as a desktop computer, laptop, tablet computer, mobile computer, smartphone, etc., suitable for implementing various embodiments as previously described. In one embodiment, the computing architecture 700 may include or be implemented as part of a system, which will be further described below. As described above, at least one computing device and/or the processing circuitries thereof may be configured to at least execute, support, provide, and/or access the various features and functionalities of a simulation platform (e.g., the production system replica, the modified production system, the docket containers, etc.).

As used in this application, the terms “system” and “component” are intended to refer to a computer-related entity, either hardware, a combination of hardware and software, software, or software in execution, examples of which are provided by the exemplary computing architecture 700. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 700 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 700.

As shown in FIG. 7, the computing architecture 700 includes processor 704, a system memory 706 and a system bus 708. The processor 704 can be any of various commercially available processors, processing circuitry, central processing unit (CPU), a dedicated processor, a field-programmable gate array (FPGA), etc.

The system bus 708 provides an interface for system components including, but not limited to, the system memory 706 to the processor 704. The system bus 708 can be any of several types of bus structure that may further interconnect to a memory bus (with or without a memory controller), a peripheral bus, and a local bus using any of a variety of commercially available bus architectures. Interface adapters may connect to the system bus 708 via slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 700 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 706 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 7, the system memory 706 can include non-volatile memory 710 and/or volatile memory 712. A basic input/output system (BIOS) can be stored in the non-volatile memory 710.

The computer 702 may include various types of computer-readable storage media in the form of one or more lower speed memory units, including an internal (or external) hard disk drive (HDD) 714, a magnetic floppy disk drive (FDD) 716 to read from or write to a removable magnetic disk 718, and an optical disk drive 720 to read from or write to a removable optical disk 722 (e.g., a CD-ROM or DVD). The HDD 714, FDD 716 and optical disk drive 720 can be connected to the system bus 708 by a HDD interface 724, an FDD interface 726 and an optical drive interface 728, respectively. The HDD interface 724 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 710, 712, including an operating system 730, one or more application programs 732, other program modules 734, and program data 736. In one embodiment, the one or more application programs 732, other program modules 734, and program data 736 can include, for example, the various applications and/or components of the system 800.

A user can enter commands and information into the computer 702 through one or more wire/wireless input devices, for example, a keyboard 738 and a pointing device, such as a mouse 740. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, track pads, sensors, styluses, and the like. These and other input devices are often connected to the processor 704 through an input device interface 742 that is coupled to the system bus 708 but can be connected by other interfaces such as a parallel port, IEEE 1394 serial port, a game port, a USB port, an IR interface, and so forth.

A monitor 744 or other type of display device is also connected to the system bus 708 via an interface, such as a video adaptor 746. The monitor 744 may be internal or external to the computer 702. In addition to the monitor 744, a computer typically includes other peripheral output devices, such as speakers, printers, and so forth.

The computer 702 may operate in a networked environment using logical connections via wire and/or wireless communications to one or more remote computers, such as a remote computer 748. The remote computer 748 can be a workstation, a server computer, a router, a personal computer, portable computer, microprocessor-based entertainment appliance, a peer device or other common network node, and typically includes many or all the elements described relative to the computer 702, although, for purposes of brevity, only a memory/storage device 750 is illustrated. The logical connections depicted include wire/wireless connectivity to a local area network (LAN) 752 and/or larger networks, for example, a wide area network (WAN) 754. Such LAN and WAN networking environments are commonplace in offices and companies, and facilitate enterprise-wide computer networks, such as intranets, all of which may connect to a global communications network, for example, the Internet.

When used in a LAN networking environment, the computer 702 is connected to the LAN 752 through a wire and/or wireless communication network interface or adaptor 756. The adaptor 756 can facilitate wire and/or wireless communications to the LAN 752, which may also include a wireless access point disposed thereon for communicating with the wireless functionality of the adaptor 756.

When used in a WAN networking environment, the computer 702 can include a modem 758, or is connected to a communications server on the WAN 754 or has other means for establishing communications over the WAN 754, such as by way of the Internet. The modem 758, which can be internal or external and a wire and/or wireless device, connects to the system bus 708 via the input device interface 742. In a networked environment, program modules depicted relative to the computer 702, or portions thereof, can be stored in the remote memory/storage device 750. It will be appreciated that the network connections shown are exemplary and other means of establishing a communications link between the computers can be used.

The computer 702 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.118 (a, b, g, n, etc.) to provide secure, reliable, fast wireless connectivity. A Wi-Fi network can be used to connect computers to each other, to the Internet, and to wire networks (which use IEEE 802.3-related media and functions).

The various elements of the devices as previously described with reference to FIGS. 1-6 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

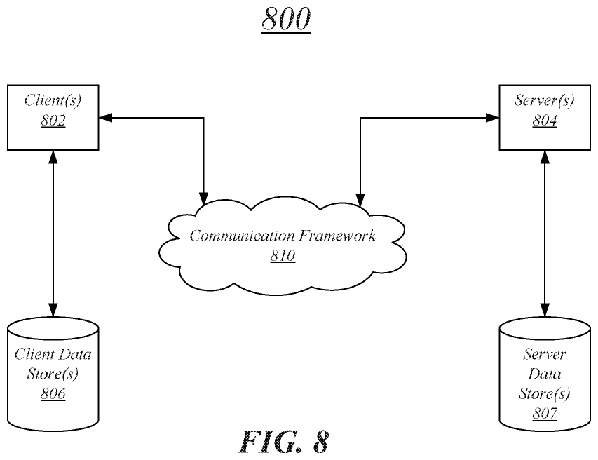

FIG. 8 is a block diagram depicting an exemplary communications architecture 800 suitable for implementing various embodiments. For example, one or more computing devices may communicate with each other via a communications framework, such as a network (e.g., a cloud-based network). At least one computing devices connected to the network may be a user computing device, such as a desktop computer, laptop, tablet computer, smartphone, etc. At least a second computing device connected to the network may be one or more server computers, which may be implemented as a back-end server or a cloud-computing server. In some embodiments, the client computing device may be configured to access and interface with the simulation platform. And the at least one server computer, for instance, may support and provide all the functionalities of the simulation platform.

The communications architecture 800 includes various common communications elements, such as a transmitter, receiver, transceiver, radio, network interface, baseband processor, antenna, amplifiers, filters, power supplies, and so forth. The embodiments, however, are not limited to implementation by the communications architecture 800.

As shown in FIG. 8, the communications architecture 800 includes one or more clients 802 and servers 804. The one or more clients 802 and the servers 804 are operatively connected to one or more respective client data stores 806 and server data stores 807 that can be employed to store information local to the respective clients 802 and servers 804, such as cookies and/or associated contextual information.

The clients 802 and the servers 804 may communicate information between each other using a communication framework 810. The communications framework 810 may implement any well-known communications techniques and protocols. The communications framework 810 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 810 may implement various network interfaces arranged to accept, communicate, and connect to a communications network. A network interface may be regarded as a specialized form of an input/output (I/O) interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.7a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 802 and the servers 804. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose and may be selectively activated or reconfigured by a computer program stored in the computer. The procedures presented herein are not inherently related to a particular computer or other apparatus. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A system for a simulation platform, the system comprising: one or more computing devices, wherein the one or more computing devices comprises:
a memory to store instructions; and
processing circuitry, coupled with the memory, operable to execute the instructions, that when executed, cause the processing circuitry to:
capture and store production data in real-time or near real-time, wherein the production data is related to a current production system;
receive one or more proposed modifications to the current production system, wherein the one or more proposed modifications are directly input by a user via a user interface as a table-based file and the one or more proposed modifications are changes in one or more measurable factors of business logic implemented in a selected production system;
generate a virtual replica of the current production system based on the captured and stored production data, wherein the virtual replica is a self-contained and unchangeable replication of the current production system;
generate a modified production system of the current production system based on the received one or more proposed modifications;
run a first simulation on the virtual replica of the current production system, wherein the first simulation outputs a first plurality of effects;
run a second simulation on the modified production system, wherein the second simulation outputs a second plurality of effects;
perform analysis on the first simulation and the second simulation; and
output a result of the performed analysis.

2. The system of claim 1, wherein the processing circuitry is further caused to:
receive user input indicating whether the one or more proposed modifications to the current production system is accepted; and
apply, automatically, the one or more proposed modifications to the current production system.

3. The system of claim 2, wherein the current production system is a most recent version of the production system prior to applying the one or more proposed modifications.

4. The system of claim 3, wherein the one or more proposed modifications includes changing a credit-related characteristic, wherein the credit-related characteristic includes a credit-related value and/or a credit score associated with a borrower.

5. The system of claim 1, wherein the one or more measurable factors of business logic includes a weight, a parameter, a threshold, and/or a limit associated with the business logic implemented in the production system.

6. (canceled)

7. The system of claim 1, wherein the first plurality of effects and the second plurality of effects each include at least a first order effect, a second order effect, and a third order effect.

8. The system of claim 1, wherein the analysis performed comprises at least a comparison between the first plurality of effects of the first simulation and the second plurality of effects of the second simulation.

9. The system of claim 1, wherein the first simulation and the second simulation are run simultaneously in parallel.

10. The system of claim 1, wherein the one or more computing devices are dedicated server computers running or supporting the simulation platform.

11. The system of claim 1, wherein the analysis is performed by one or more operating-system-level virtualization software packages for performing at least operating-level virtualization, wherein the one or more operating-system-level virtualization software packages are isolated from each other and each includes one or more respective tools, libraries, and/or configuration files.

12. The system of claim 1, wherein the result of the performed analysis is output on an interface, the interface displaying and/or highlighting any changes between the first plurality of effects of the first simulation and the second plurality of effects of the second simulation.

13. The system of claim 1, wherein the simulation platform is provisioned in a cloud environment.

14. An apparatus comprising:
a memory to store instructions; and
processing circuitry, coupled with the memory, operable to execute the instructions, that when executed, cause the processing circuitry to:
receive one or more proposed modifications to a current production system, wherein the one or more proposed modifications are directly input by a user via a user interface as a table-based file and the one or more proposed modifications are changes to one or more parameters or thresholds of decisioning rules applied by a selected production system;
send the one or more proposed modifications to a simulation platform;
receive or access a result of an analysis performed on a first simulation and a second simulation, wherein the first simulation is run on a replica of the current production system and the second simulation is run on a modified production system based on the one or more proposed modifications to the current production system, wherein the replica is a self-contained and unchangeable replication of the current production system; and
display, via an interface, any changes between the first simulation and the second simulation.

15. The apparatus of claim 14, wherein the processing circuitry is further caused to inform the simulation platform that the one or more proposed modifications have been accepted, wherein the one or more proposed modifications are automatically applied to the current production system by the simulation platform.

16. The apparatus of claim 14, wherein the apparatus communicates with the simulation platform via a cloud-based network.

17. A non-transitory computer-readable storage medium storing computer-readable program code executable by a processor to:
capture and store production data that is related to a current production system;
receive one or more proposed modifications to the current production system, wherein the one or more proposed modifications are directly input by a user via a user interface as a table-based file and the one or more proposed modifications are changes in one or more measurable factors of business logic implemented in a selected production system;
run a first simulation on a virtual replica of the current production system, wherein the first simulation outputs a first plurality of effects, wherein the virtual replica is a self-contained and unchangeable replication of the current production system;
run a second simulation on a modified production system based on the one or more proposed modifications to the current production system, wherein the second simulation outputs a second plurality of effects;
perform analysis on the first simulation and the second simulation; and output a result of the performed analysis.

18. The non-transitory computer-readable storage medium of claim 17, further comprising computer-readable program code executable to:
receive user input indicating whether the one or more proposed modifications to the current production system is accepted; and
apply, automatically, the one or more proposed modifications to the current production system.

19. The non-transitory computer-readable storage medium of claim 17, wherein the analysis is performed by one or more operating-system-level virtualization software packages.

20. The non-transitory computer-readable storage medium of claim 17, wherein the result of the performed analysis is output on an interface, the interface displaying and/or highlighting any changes between the first simulation and the second simulation.

21. The system of claim 11, wherein the one or more operating-system-level virtualization software packages communicate with each other via one or more channels.
